(19) United States
(12) Patent Application Publication
(10) Pub. No.: US 2010/0285777 A1
(43) Pub. Date: Nov. 11, 2010

(54) METHOD, APPARATUS AND SYSTEM FOR ENABLING COMMUNICATIONS BETWEEN USERS

(75) Inventors: Oleg Golobrodsky, Petach Tikva (IL); Gideon Drori, Sha'arei Tikva (IL)

Correspondence Address: BROWDY AND NEIMARK, P.L.L.C.;624 NINTH STREET, NW, SUITE 300, WASHINGTON, DC, 20001-5303, US

(73) Assignees: Oleg GOLOBRODSKY, Petach Tikva (IL); Gideon DRORI, Sha'arei Tikva (IL); Itzhak PETERBURG, Tal Shahar (IL); Moshe PETERBURG, Ramat Hasharon (IL)

(21) Appl. No.: 12/666,915

(22) PCT Filed: Jun. 16, 2008
(86) PCT No.: PCT/IL2008/000818

§ 371 Date: Jul. 12, 2010

(30) Foreign Application Priority Data
Jun. 28, 2007 (IL) 184,305

(51) Int. Cl. H04W 4/00

(52) U.S. Cl. 455/412.2

(57) ABSTRACT

A user status notification system is provided which comprises: a first communication device that comprises a status reporting means operative to forward current status of the first user towards a status provisioning apparatus; a second communication device operative to forward a request to receive status information associated with the first user; a status request processing apparatus adapted to retrieve capabilities associated with the second communication device, to process the status information request initiated by the second user, and to forward the processed status request towards a status information provisioning apparatus; a status provisioning apparatus adapted to receive the processed status request, to retrieve information about the first user current status and to forward the retrieved information towards the second user device; and means operative to establish a communication session between the first and second users in accordance with the users' devices capabilities as retrieved by the status request processing apparatus.

### FIELD OF THE INVENTION

The present invention relates to telecommunication apparatus and methods, and in particular, to apparatus and methods adapted to allow provisioning of services via communication devices.

### BACKGROUND OF THE INVENTION

Several techniques have been developed for connecting to or accessing Internet-based information resources on the World Wide Web (WWW) using conventional graphical user interface (GUI) based Internet browser programs. The availability of any particular Web-site surfing technique depends on where the Internet user finds himself or herself in the Internet browser program at any particular instant of time.

For example, if one is currently at a Web-site (i.e., in a particular HyperText Markup Language (HTML) document), at which there is a highlighted or embedded “link” specifying an Internet address of another Web-site (i.e., another HTML document), then the user can access (i.e., “surf to”) this other Web-site by simply “clicking on” or selecting the highlighted URL with his/her “mouse” in a conventional manner.

A typical process to access that information begins once the user has clicked on the link, or manually print the URL of the information resource into the browser program. More recently, with the growth and ever increasing complexity of the WWW, new services have been widely in use, services such as MSN, I Seek You (“ICQ”), and the like which require intensive interacting with the users of these services. Typically, in order to provide these services, the provider of the service uses one or more servers, with which the users communicate in order to receive the requested service. However, in order to enable such communications, the device used by the user should be an end device, such as a personal computer (PC), a laptop, etc., having an IP address that is used for exchanging messages between the user and the target, via the server(s) of the service provider. Once the user has defined the service he/she would like to receive, e.g. by entering the WWW address of that service provider, then the browser program automatically connects the user's client system (i.e., Internet access terminal) to the Internet Server computer that supports the selected Web-site (service provider address).

In our co-pending application published under US 2008/0005299, a method is described for providing a user of a telephone device with a capability to use Internet-based applications. By the method described, a user of a mobile telephone sends an indication towards a first server requesting to be connected to an application residing at a second server. Next, a communication path is established, one which extends between the telephone device and the second server via the first server, and thereafter, a virtual client entity is created at the first server to allow communication between the telephone device and the requested application, for the duration of the communication session that is about to take place.

In another co-pending application of the Applicant, published under US 2008/0126510 a method is described to provide a mobile telephone user with an indication that a message was sent to him/her via an Internet-based application, irrespective of whether that user is currently actively connected to that application or not. The method disclosed comprises receiving at the Internet-based application server a message which has been addressed to the user, forwarding the message to another server at which a virtual client entity was previously created for establishing a communication session associated with the mobile telephone user via the Internet-based application, and if the user is not currently actively connected to that Internet-based application, storing the message at the other server and providing the user an indication that a message is waiting for him.

One of the interesting aspects involved with Internet-based application is the aspect of presence. The public switched telephone network (“PSTN”) can provide some basic presence information, e.g. whether a phone connected to this network is on- or off-hook, when a call is initiated. However, the PSTN cannot provide more sophisticated/advanced information such as information that relates to the willingness of the other party to receive calls, not just his/her ability to do so, before the establishment of a call is attempted. Also, the PSTN does not provide the option for one to choose which users appear on his/her list of contacts and to receive a display of their current status, such as offline, busy, and so on.

### SUMMARY OF THE INVENTION

It is therefore an object of the present invention to provide a user of a communication device with means and methods to inform others of his/her availability for communication.

It is yet another object of the present invention to provide methods and devices adapted to provide a user of a communication device with information related to the current availability for communication of members included in a pre-selected group of people.

It is still a further object of the present invention to provide a system for requesting the status of a user, recognizing the status, and forwarding the status to one or more requesting users.

Other objects of the invention will become apparent as the description of the invention proceeds.

Thus, in accordance with a preferred embodiment of the present invention there is provided a user status notification system which comprises:

at least one first communication device associated with a first user, wherein each of the at least one communication device is connectable to a communication network and comprises a status reporting means operative to forward current status of the first user towards a status provisioning apparatus;

at least one second communication device connected to the communication network and associated with a second user, and adapted to forward a request initiated by the second user to receive status information associated with the first user, towards a status request processing apparatus;

a status request processing apparatus connectable to the communication network, and adapted to:

retrieve capabilities associated with the at least one second communication device;

process the status information request initiated by the second user; and

forward the processed status request towards a status information provisioning apparatus;

a status provisioning apparatus adapted to receive the processed status request from the status request processing apparatus, to retrieve information about the first user current status and to forward the retrieved information towards the at least one communication device of the second user via the status request processing apparatus; and

means operative to establish a communication session between the first and second users in accordance with the users' devices capabilities as retrieved by the status request processing apparatus.

Preferably, the communication session is established in case the current status of each of the first and second users allows establishing such a communication session there between.

It should be noted that throughout the specification and claims the term “user” encompasses any entity, preferably human, that operates a communication terminal.

It should also be noted that the term “a communication device” as used herein refers to any type of a device that comprises a SIP client software and enables connecting its user to and communicating via a communications network, such as a device could be a landline telephone, a mobile telephone, a PDA, an IPTV setop box, a personal computer (PC) and the like.

In accordance with a preferred embodiment of the invention, the status request processing apparatus is further adapted to store a communication address associated with the at least one second communication device. Preferably, this stored communication address is used in the process of establishing the requested communication session at a later stage, if this process cannot be carried out immediately in response to receiving the request initiated by the second user to establish the communication session.

According to a preferred embodiment of the invention, the system further comprises a storage means adapted to store a list of user names associated with the second user, their respective communication addresses and their current status information.

The term “communication address” as used herein should be understood to encompass a telephone number, and/or instant messaging (“IM”) user address, and/or SIP address, and/or IPTV setop box address, and the like.

By yet another embodiment of the invention, a request for current status information relating to the selected user name is initiated by the at least one second communication device in response to the second user selection of a user name from among the list of user names associated therewith.

In accordance with another preferred embodiment of the invention the at least one first communication device comprises a user interface adapted to receive input from the first user. The input received from that user would allow initiating and forwarding an update of the first user current status towards the status provisioning apparatus.

According to still another embodiment of the invention, the first user is provided with a list of options to define his/her current status. The selected option is not necessarily related to the current status of the communication path along which the user, who selects the option, is connected to the communication network. For example, the communication path may be free to establish a communication session with the user, but the user may still select the option of “unavailable”. Similarly, the user may be engaged in a voice session but his/her current status may be defined “available for text messages”, etc.

By yet another embodiment, the at least one first communication device comprises means to determine its current status. Preferably, such a determination will be used as the user's default option if no other input is received from the user of the device. Optionally, the at least one first communication device is adapted to initiate a process for forwarding information about updated current status towards the status provisioning apparatus, in response to a change occurring in the current status of a communication path connecting that device to the communication network.

In accordance with still another preferred embodiment of this aspect of the invention, the system further comprises means for establishing a communication path in order to connect the communication device of the second user with the communication device of the first user, once the current status of the first user becomes a suitable option for establishing such a connection.

Preferably, a suitable current status option is a pre-defined current status or a member of a group comprising a number of pre-determined current status options.

According to yet another preferred embodiment of the invention, the information related to the current status of the first user is derived automatically based on current usage of the at least one first communication device, or based on input received from the first user or any combination thereof.

In accordance with another preferred embodiment, the at least one first communication device comprises a user interface adapted to receive an input from the user of the device, and wherein the input received from the user allows initiating an update of the user current status for use in the communication network.

In accordance with another aspect of the present invention, there is provided a method for providing a status of a user of at a least one first communication device which is connectable to a communication network, the method comprising:

forwarding by the at least one first communication device a status information associated with that first user, towards a communication network;

storing the status information;

updating the stored status information in response to a change occurring in the status of the first user;

communicating a request for information about the first user status, by at least one other user associated with at least one other communication device connected to the communication network;

retrieving information that relates at least to the capabilities of the communication device of the other user;

processing the information request and forwarding it towards a status provisioning apparatus;

retrieving updated information relating to the first user current status;

forwarding an indication of the first user current status towards the at least one other communication device; and

establishing a communication session between said first and second users in accordance with the users' devices capabilities as retrieved by said status request processing apparatus.

Preferably, the step of establishing the communication session is carried out in case the current status of each of the first user and the at least one other user allows establishing such a session.

In accordance with a preferred embodiment of this aspect of the invention, the current status of the first user is determined based upon information inputted by that first user.

According to another a preferred embodiment of this aspect of the invention, the method provided further comprising a step of providing the first user with a list of options to define his/her current status, and enabling the first user to select a current status to be associated with him/her from among the options provided.

By yet another preferred embodiment of this aspect of the invention, the method provided further comprises a step of automatically determining a default user's current status in accordance with the current status of a communication path connecting that at least one first communication device with the communication network. Optionally or in addition, the method provided further comprises initiating a new user status report in response to a change in the current status of the communication path.

In accordance with still another aspect of the invention there is provided a user communication device comprising:

a status reporting means operative to forward current status of a user using the user communication device towards a storage means;

a user interface adapted to receive input from the user of the user communication device related to his/her current status, and wherein the input received from the user allows initiating an update of the user's current status to be forwarded towards the storage means.

The term “user communication device” as used herein throughout the specification and claims, should be understood to encompass an end user device that is used by that user for communication such as a mobile telephone, a setop box, a remote control of an IPTV which is used to communicate via the setop box, a landline telephone device and the like.

According to a preferred embodiment of this aspect of the invention, the user communication device further comprising a display means to enable displaying a list of options from which the user of the handheld device can select a definition of his/her current status.

In accordance with another preferred embodiment of this aspect of the invention, the user communication device further comprises means to allow determining its own current status based on its current mode of operation and preferably to initiate a process for forwarding updated information about the change in the current status towards the storage means, in response to a change occurring in the current status of a communication path connecting this user communication device to a communication network.

By yet another preferred embodiment of this aspect of the invention, the current status of the user communication device user is derived automatically based on current mode of operation of the user communication device, or based on an input received from the user communication device user or any combination thereof.

In accordance with still another preferred embodiment of this aspect of the invention, the user communication device further comprises means to allow requesting information related to current status of another user. Preferably, the user communication device further comprising a processor capable of processing the request for information related to the current status of the other user and to forward the processed request towards a status provisioning apparatus associated with a communication network to which the user communication device is connected.

By still another preferred embodiment, the user communication device further comprising storage means for storing a list of user names and their respective communication addresses, and in response to a selection of a user name from among that list of user names, initiating a request for current status information relating to the user whose name was selected and forwarding the request towards a communication network to which the user communication device is connected.

In accordance with still another aspect of the present invention there is provided a user status notification apparatus comprising:

communication means operative to allow the user status notification apparatus to receive and to forward status information related to a plurality of end users, along a communication network;

a processor adapted to:

receive one or more requests for information related to the current status of one or more of the plurality of end users, initiated by at least one other of the plurality of end users;

process the one or more requests for information;

retrieve the requested information relating to the current status of the corresponding one or more of the plurality of end users; and

forward the retrieved information via the communication network towards the at least one other end user who initiated the respective request,

and wherein the user status notification apparatus is operative to receive status related information inputted by a respective end user, and wherein the inputted information does not necessarily coincide with the current status of the communication path connecting the communication device of the end user inputting that status related information.

According to another preferred embodiment, the user status notification apparatus further comprises means operative to retrieve operating capabilities of the communication devices associated with the at least one other of the plurality of end users. Preferably, the user status notification apparatus is operative to establish a communication session between at least two of the plurality of end users, based on the capabilities of their respective communication devices retrieved by the means operative to retrieve the operating capabilities.

By still another preferred embodiment, the user status notification apparatus further comprising means operative to store a communication address associated with the at least one of the communication devices associated with the at least one other of the plurality of end users.

In accordance with yet another preferred embodiment, the user status notification apparatus further comprises means operative to store user names and their respective communication addresses associated with the one or more of the plurality of end users.

### BRIEF DESCRIPTION OF THE DRAWINGS

The present invention will be understood and appreciated from the following detailed description, taken in conjunction with the drawings in which:

FIG. 1—is a simplified block diagram of a telephone status notification system constructed and operative in accordance with a preferred embodiment of the present invention;

FIG. 2—is another schematic representation of a system constructed and operative in accordance with a preferred embodiment of the present invention; and

FIG. 3—is a schematic block diagram exemplifying a method carried out according to a preferred embodiment of the invention.

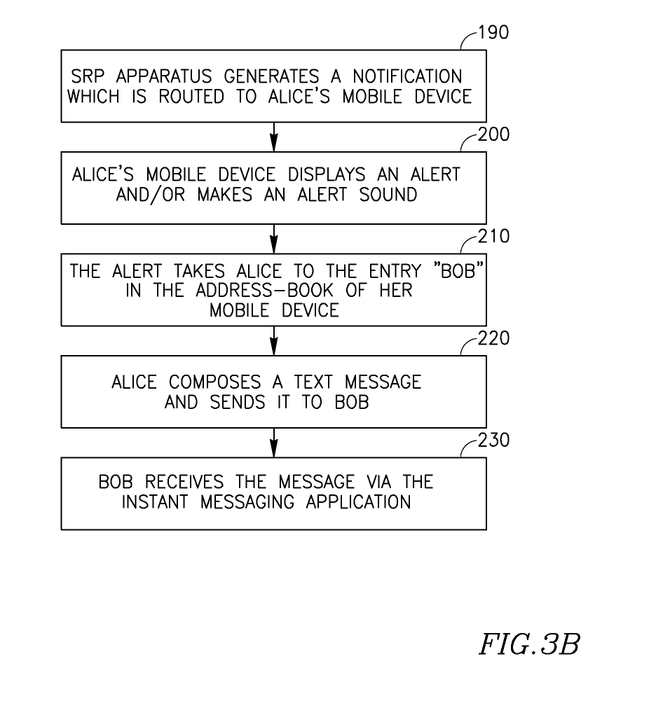

### DETAILED DESCRIPTION OF PREFERRED EMBODIMENTS

A better understanding of the present invention is obtained when the following non-limiting detailed description of the following examples is considered in conjunction with the accompanying drawings.

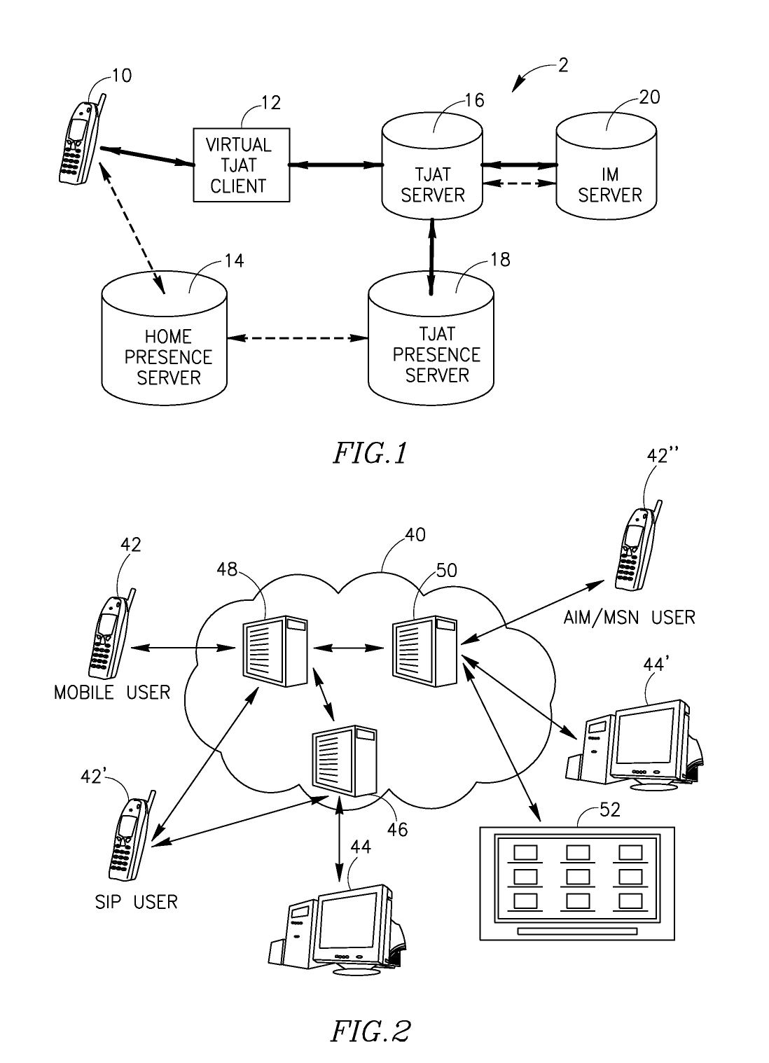

Let us consider now FIG. 1 which is a simplified block diagram of an exemplified telephone status notification system 2 constructed and operative in accordance with a preferred embodiment of the present invention. By this example, mobile telephone 10 that comprises a client software, is able to communicate either with virtual client software 12 such as SIP, IMPS, SIMPLE or any other protocol software that enables establishing a communication session between a plurality of devices, associated with a status request processing apparatus (e.g. TJAT™ server 16) or with its home presence server 14. The latter is operative to communicate with TJAT presence server 18. The two TJAT severs 16 and 18 can also communicate with each other, and TJAT server 16 is further operative to communicate with the appropriate instant message application server (the status provisioning apparatus), such as ICQ server 20.

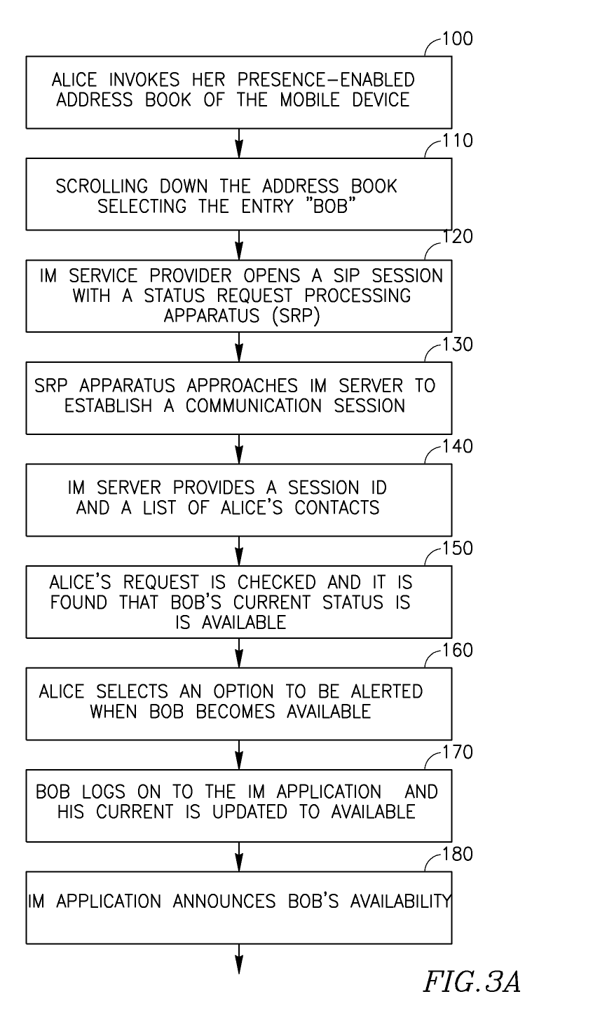

FIG. 2 illustrates a schematic representation of a system constructed and operative in accordance with a preferred embodiment of the present invention, and the relationship between the different entities. The communication network 40 shown in this FIG, comprises a first gateway 48 that is operative to allow communication with telephone users whether they are provided with a SIP software such as a landline telephone 42′ or not, such as mobile telephone 42. SIP user 42′ may be also connected to the network through a second gateway 46 (being a SIP gateway). Other devices can also be connected to gateway 46 such as IPTV device 44. Each of these gateways is capable of functioning as a status request processing apparatus. A third gateway illustrated in this FIG. is the instant messaging gateway 50 which provides the connectivity to the various IM applications such as AOL, AIM, MSN and the like on the one hand, and is operative as a status provisioning apparatus. At the same time this gateway 50 is also capable of communicating with different users of these applications such as the AIM/MSN telephone user 42″, IPTV user 44′ and PC user 52, so that eventually these users can be connected through gateways 46 and 48 to users 42, 42′ and 44 while gateways 46 and 48 provide the respective users with the capability to be connected by using one or more of the embodiments described herein.

Nowadays, typically only about 5% of new handsets' sales are of smart-phones, and generally they are the only ones with the capability of running currently available IMS (IP-Multimedia Subsystem) applications, so one of the biggest challenges for IMS is getting applications onto the handset. Another problem is that services involving multimedia, presence, and follow-me features constitute a huge technical barrier for successful IMS deployment.

In addition, the traditional, successful IM communities such as ICQ and others use proprietary protocols and are currently not IMS enabled, therefore the existence of these large communities using proprietary protocols poses a problem for SIP based IMS communities.

The architecture illustrated in FIG. 1 allows seamless access and enable convergence of the application—Any Where, Any Network, and Any Device. For instant messaging (“IM”), this means enabling access to one's community (ICQ, Messenger, AIM, Enterprise or other), it means access through any network (e.g. fixed line broadband, WiFi or 3G wireless, etc.) and access from multiple devices (PC, mobile handset, Home Entertainment Center, . . . ).

The use of TJAT system that includes servers 16 and 18, with its browser based solution can enable seamless access to subscriber communities today, enabling all subscribers, even those without the ability to run IMS IM clients on their handsets to access any IM community (ICQ, AIM, Messenger or even IMS SIP based IM), complementing all other IMS IM solutions deployed.

Another feature of mobile IM in the next generation network according to some vendors and operators is the merging of the buddy list and the subscriber mobile contact list, enabling the subscriber to decide per case on sending an SMS, MMS or IM from an easy and integrated user interface. Such a unified interface feature is part of the TJAT platform described herein.

Each user (e.g. of device 10) in FIG. 1 has a unique SIP address (assuming for sake of simplicity that SIP is the protocol used in this example), similar to an email, where the user and the home network are designated.

SIP addresses have optional parts, meaning that several representations of addresses (some with attributes) are possible:

BigGuy<sip:UserA@atlanta.com>

sip:+13145551111@ss1.atlanta.com;user=phone

sips:alice@atlanta.com;transport=tcp.

The address itself is unique. It is assigned by the operator to the subscriber and used to register subscriber presence and participation in SIP sessions.

A basic SIP session setup involves a SIP UA client sending a request to the SIP URL of the called endpoint (UAS), inviting it to a session. If the UAC recognizes the IP address of the UAS, it can send the request. Otherwise, the UAC sends the request to a proxy or redirect server to locate the user. That server might forward the request to other servers until the user is located. After the SIP address is resolved to an IP address, the request is sent to the UAS. If the user takes the call, capabilities are negotiated and the call commences. If the user does not take the call, it can be forwarded to voice mail or another number.

Typically the following SIP components are used:

SIP Registrar:
accept registration requests from users;
maintains user's whereabouts at a Location Server (like GSM HLR);

SIP Proxy Server:
relays call signaling, i.e. acts as both client and server;
operates in a transactional manner, i.e., it keeps no session state;
transparent to end-devices;
does not generate messages on its own (except ACK and CANCEL);
allows for additional services (call forwarding, AAA, forking, etc.);

SIP Redirect Server
redirects users to other servers;

According to an embodiment of the present invention, there is provided a logical entity that is associated with presence information, being a dynamic set of information that comprises presence related elements such as the status, reachability, willingness, capabilities and the like. Thus the current status may be for example any one of the following: user is busy, user is away, user not available for the next xx minutes, user available for SMS, available for chat, and any other status that can be either inputted by the user or derived from the current usage of the phone, such as line busy, when the cellular phone displays a video clip and its resources are low, to update the user availability to “user available for SMS” only, etc.

The presence information may be composed from information derived from a plurality of presence sources. A Presentity is most commonly used a reference to a person, although it may represent a function such as “help desk” or a resource such as “conference room #27”.

TJAT Presence Server 18 is a logical entity that is capable of receiving presence information from a multitude of presence sources pertaining to the Presentities it serves and makes this information available to Watchers according to the rules associated with those Presentities.

Let us now consider an example of sending an instant message between IMS/SIP clients in accordance with an embodiment of the invention.

Step 100: Alice invokes her presence-enabled address-book of her mobile device.

Step 110: Alice scrolls down her address book and selects the entry “Bob”. This selection is translated into a selection of an instant messaging (IM) channel and triggers a request for information about Bob's current status.

Step 120: Alice's IMS service provider opens a SIP session with a status request processing apparatus, and in that session the definitions of Alice's mobile device are provided to the status request processing apparatus;

Step 130: The status request processing apparatus then approaches the appropriate status information provisioning apparatus, which is in this example the instant messaging server (e.g. the ICQ server), and requests the establishment of a session on behalf of Alice;

Step 140: The status information provisioning apparatus responds by providing the status request processing apparatus with a session ID and with a list of Alice's contacts;

Step 150: Alice's request is checked and it is found that Bob's current status is unavailable. Meanwhile, the status request processing apparatus has acquired the communication addresses of both Alice and Bob;

Step 160: Alice selects an option to be alerted when Bob becomes available;

Step 170: Later, Bob logs on to the Instant Messaging application on his desktop PC, and as soon as the update of his current status is received at the status information provisioning apparatus, the “Available” profile is automatically selected;

Step 180: Bob's Instant Messaging application announces Bob's availability, as well as some additional information, such as the capability of the Instant Messaging application to send and receive IM message to the status request processing apparatus;

Step 190: the status request processing apparatus generates a notification indicating the change in Bob's current status which is routed to Alice's mobile device;

Step 200: Alice's mobile device displays an alert and/or makes an alert sound;

Step 210: Alice selects the alert which takes her to the address-book of her mobile device the entry of Bob;

Step 220: Alice sees that Bob is available for text messaging, so she composes a text message and sends it to Bob;

Step 230: Bob receives the message via Instant Messaging.

It will be appreciated that a notification system as described hereinabove may be used in conjunction with IP telephones designed for use with the Internet, where the IP telephones comprise computer circuitry and voice processing capability.

It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination.

It is to be understood that the above description only includes some embodiments of the invention and serves for its illustration. Numerous other ways of carrying out the methods provided by the present invention may be devised by a person skilled in the art without departing from the scope of the invention, and are thus encompassed by the present invention.

1. A user status notification system comprising:
at least one first communication device associated with a first user, wherein each of said at least one communication device is connectable to a communication network and comprises a status reporting means operative to forward current status of the first user towards a status provisioning apparatus;
at least one second communication device connected to said communication network and associated with a second user, and adapted to forward a request initiated by said second user to receive status information associated with said first user, towards a status request processing apparatus;
a status request processing apparatus connectable to said communication network, and adapted to:
retrieve capabilities associated with said at least one second communication device;
process said status information request initiated by said second user; and
forward the processed status request towards a status information provisioning apparatus;
a status provisioning apparatus adapted to receive said processed status request from said status request processing apparatus, to retrieve information about the first user current status and to forward the retrieved information towards said at least one communication device of the second user via the status request processing apparatus; and
means operative to establish a communication session between said first and second users in accordance with the users' devices capabilities as retrieved by said status request processing apparatus.

2. A system according to claim 1, wherein said status request processing apparatus is further adapted to store a communication address associated with said at least one second communication device.

3. A system according to claim 2, wherein said communication address is used in a process of establishing said communication session, in case the current status of each of said first and second users does allow establishing said communication session in response to receiving the request initiated by said second user to establish said communication session.

4. A system according to claim 1, further comprising a storage means adapted to store a list of user names associated with said second user, their respective communication addresses and their current status information.

5. A system according to claim 1, wherein said at least one first communication device comprises a user interface adapted to receive input from said first user, and wherein the input received from said user allows initiating an update of the first user current status to be forwarded towards said status provisioning apparatus.

6. A system according to claim 1, wherein said first user is provided with a list of options to define his current status.

7. A system according to claim 6, wherein the option selected is not related to the current status of a communication path along which said at least one first communication device is connected to said communication network.

8. A system according to claim 1, wherein said at least one first communication device comprises means to determine its current status.

9. A system according to claim 8, wherein said at least one first communication device is adapted to initiate a process for forwarding information about updated current status towards said status provisioning apparatus, in response to a change occurring in the current status of a communication path connecting said device to the communication network.

10. A system according to claim 1, further comprising means for establishing a communication path for connecting the communication device of said second user with the communication device of said first user, provided that the current status of the first user is a suitable option for carrying out such a connection.

11. A system according to claim 10, wherein a suitable current status option is a pre-defined current status or a member of a group comprising a number of pre-determined current status options.

12. A system according to claim 1, wherein the information related to the current status of the first user is derived automatically based on current usage of the at least one first communication device, or based on input received from said first user or any combination thereof.

13. A method for providing a status of a user of a first communication device, the method comprising:
providing at least one first communication device associated with a first user, connectable to a communication network;
forwarding by said at least one first communication device a status information associated with said first user, towards a communication network;
storing said status information;
updating said stored status information in response to a change occurring in the status of said first user;
communicating a request for information about the first user status, by at least one other user associated with at least one other communication device connected to said communication network;
retrieving information that relates at least to the capabilities of the communication device of said other user;
processing the information request and forwarding it towards a status provisioning apparatus;
retrieving updated information relating to said first user current status;
forwarding an indication of the first user current status towards said at least one other communication device; and
establishing a communication session between said first and second users in accordance with the users' devices capabilities as retrieved by said status request processing apparatus.

14. A method according to claim 13, wherein the current status of said first user is determined based upon information inputted by said first user.

15. A method according to claim 13, further comprising a step of providing said first user with a list of options to define his current status, and enabling said first user to select a current status to be associated therewith from among said options provided.

16. A method according to claim 13, further comprising a step of automatically determining a default user's current status in accordance with the current status of a communication path connecting said at least one first communication device with said communication network.

17. A method according to claim 16, further comprising initiating a new user status report in response to a change in the current status of said communication path.

18. A user communication device comprising:
a status reporting means operative to forward current status of a user using said user communication device towards a storage means;
a user interface adapted to receive input from the user of said user communication device related to his current status, and wherein the input received from said user allows initiating an update of said user current status to be forwarded towards the storage means.

19. A user communication device according to claim 18, further comprising a display means to enable displaying a list of options from which the user of said user communication device can select an appropriate current status.

20. A user communication device according to claim 18, further comprising means to allow determining its own current status and to initiate in response to a change occurring in the current status of a communication path connecting said user communication device to a communication network, a process for forwarding updated information about the change in the current status towards said storage means.

21. A user communication device according to claim 18, wherein the current status of the user communication device user is derived automatically based on current mode of operation of said user communication device, or based on an input received from said user communication device user or any combination thereof.

22. A user communication device according to claim 18, further comprising means to allow requesting information related to current status of another user.

23. A user communication device according to claim 22, further comprising a processor capable of processing the request for information related to the current status of said other user and to forward said processed request towards a status provisioning apparatus associated with a communication network to which said user communication device is connected.

24. A user communication device according to claim 22, further comprising storage means for storing a list of user names and their respective communication addresses and in response to a selection made by a user of said user communication device of a user name from among said list of user names, initiating a request for current status information relating to said user whose name was selected and forwarding said request towards a communication network to which the user communication device is connected.

25. A user status notification apparatus comprising:
communication means operative to allow said user status notification apparatus to receive and to forward along a communication network, status information related to a plurality of end users;
a processor adapted:
to receive one or more requests for information related to the current status of one or more of said plurality of end users, initiated by at least one other of said plurality of end users;
to process said one or more requests for information;
to retrieve the requested information relating to the current status of the corresponding one or more of said plurality of end users; and
to forward the retrieved information via the communication network towards said at least one other end user who initiated the respective request,
and wherein said user status notification apparatus is operative to receive status related information inputted by a respective end user, and wherein the inputted information does not necessarily coincide with the current status of the communication path connecting the communication device of said end user inputting said status related information.

26. A user status notification apparatus according to claim 25, further comprising means operative to retrieve operating capabilities of the communication devices associated with said at least one other of the plurality of end users.

27. A user status notification apparatus according to claim 26, operative to establish a communication session between at least two of said plurality of end users, based on the capabilities of their respective communication devices retrieved by said means operative to retrieve operating capabilities.

28. A user status notification apparatus according to claim 25, further comprising means operative to store a communication address associated with the at least one of the communication devices associated with said at least one other of said plurality of end users.

29. A user status notification apparatus according to claim 25, further comprising means operative to store user names and their respective communication addresses associated with said one or more of the plurality of end users.
